(19) United States
(12) Patent Application Publication
(10) Pub. No.: US 2011/0310262 A1
(43) Pub. Date: Dec. 22, 2011

(54) IMAGE PROCESSING DEVICE AND SHAKE CALCULATION METHOD

(75) Inventors: Yuri WATANABE, Machida (JP); Kimitaka Murashita, Kawasaki (JP); Yasuto Watanabe, Kawasaki (JP)

(73) Assignee: Fujitsu Limited

(21) Appl. No.: 13/220,335

(22) Filed: Aug. 29, 2011

Related U.S. Application Data
(63) Continuation of application No. PCT/JP2009/001010, filed on Mar. 5, 2009.

(51) Int. Cl. H04N 5/228

(52) U.S. Cl. 348/208.1

(57) ABSTRACT

A method of calculating camera shake using first and second images obtained by continuous shooting includes: extracting first and second feature points located in positions symmetrical about a central point in the first image; searching for the first and second feature points in the second image; and calculating the camera shake based on coordinates of the first and second feature points extracted from the first image and coordinates of the first and second feature points searched for in the second image.

### CROSS-REFERENCE TO RELATED APPLICATION

This application is a continuation of an international application PCT/JP2009/001010, which was filed on Mar. 5, 2009.

### FIELD

The embodiments described in the present application is related to a device and a method for processing a digital image, and may be applied to, for example, a camera-shake correction function of an electronic camera.

### BACKGROUND

An electronic camera provided with a camera-shake correction function has recently been commercialized. The camera-shake correction is realized by an optical technique or an image processing. The camera-shake correction by image processing is realized by, for example, synthesizing a plurality of images obtained by continuous shooting and aligned appropriately.

The camera shake occurs by moving a camera during shooting. The movement of the camera is defined by the six elements illustrated in FIG. 1.
(1) YAW
(2) PITCH
(3) Horizontal movement
(4) Vertical movement
(5) ROLL
(6) Perspective movement

However, when a camera is shaken in the YAW direction, the image is shifted approximately in the horizontal direction. When the camera is shaken in the PITCH direction, the image is shifted approximately in the vertical direction. Therefore, the relationship between the movement element of the camera and the shift component is illustrated in FIG. 2.

As the technology relating to the camera-shake correction, an image processing device for position correction using a pixel having the maximum edge strength is proposed (for example, Japanese Laid-open Patent Publication No. 2005-295302). In addition, there is also an image processing device proposed for selecting images indicating the same direction of camera shake from among a plurality of frames of images, grouping the selected images, and performing position correction so that the feature points of the images in the same group are match one another (for example, Japanese Laid-open Patent Publication No. 2006-180429). Furthermore proposed is an image processing device for tracking a specified number of feature points, calculating the total motion vector of the image frames, and correcting the camera shake based on the total motion vector (for example, Japanese Laid-open Patent Publication No. 2007-151008).

The shift of an image by camera shake can be considered by separating them into components of translation, rotation, and enlargement/reduction. However, when an arbitrary pixel in an image is picked up, the movement of the coordinates of the target pixel appears as the horizontal movement and the vertical movement for any of the translation, rotation, and enlargement/reduction.

FIG. 3A illustrates a translational motion between a first image and a second image obtained by continuous shooting. In this example, the feature point P1 in the first image has moved to the feature point P2 in the second image. X_{T} indicates the amount of movement in the X-axis direction (horizontal direction) caused by the translation, and Y_{T} indicates the amount of movement in the Y-axis direction (Vertical direction) caused by the translation.

FIG. 3B illustrates a rotation made between the images. In this example, the image rotates θ degrees, thereby moving the feature point P1 in the first image to the feature point P2 in the second image. X_{R} indicates the amount of horizontal movement caused by the rotation, and Y_{R} indicates the amount of vertical movement caused by the rotation. FIG. 3C illustrates the enlargement/reduction caused between the images. In this example, the image is enlarged S times, thereby moving the feature point P1 in the first image to the feature point P2 in the second image. X_{S} indicates the amount of horizontal movement caused by the enlargement, and Y_{S} indicates the amount of vertical movement caused by the enlargement.

Therefore, the amount of movement of an image by camera shake (difference (x-x′, y-y′) between the coordinates (x, y) of the feature point in a reference image and the coordinates (x′, y′) of the corresponding feature point in a searched image) may include movement components of rotation and/or enlargement/reduction. That is, the amount of movement x-x′ may include the translation component (component of movement caused by translational motion) X_{T}, the rotation component (component of movement caused by rotation) X_{R}, and the enlargement/reduction component (component of movement caused by enlargement/reduction) X_{S}. Similarly, the amount of movement y-y′ may include the translation component Y_{T}, the rotation component Y_{R}, and the enlargement/reduction component Y_{S}.

The translation component (X_{T}, Y_{T}) is constant in all areas in the image. However, the movement component by rotation (X_{R}, Y_{R}) and the movement component by enlargement/reduction (X_{S}, Y_{S}) depend on the position in the image.

Therefore, in the conventional technology, it is difficult to separate the translation component, the rotation component, and the enlargement/reduction component with high accuracy from the difference in coordinates of feature points between the images. Unless the translation component, the rotation component, and the enlargement/reduction component are separated with high accuracy, the error of an image transformation by an affine transformation grows, and the images cannot be appropriately synthesized in the camera-shake correction.

### SUMMARY

According to an aspect of an invention, a method of calculating camera shake using first and second images obtained by continuous shooting includes: extracting first and second feature points located in positions symmetrical about a central point in the first image; searching for the first and second feature points in the second image; and calculating the camera shake based on coordinates of the first and second feature points extracted from the first image and coordinates of the first and second feature points searched for in the second image.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory view of the movement element of a camera;

FIG. 2 is a table indicating the relationship between the movement element of a camera and the shift component of the image;

FIG. 3A-3C are explanatory views of the position shift by the translation, rotation, and enlargement/reduction;

FIG. 4 is a flowchart of an example of the camera shake correcting process;

FIG. 5 illustrates an example of an image transformation by the affine transformation;

FIG. 6 and FIG. 7 are explanatory views of the shake detection method according to an embodiment;

FIG. 8 illustrates a configuration of the image processing device having the shake detection function according to an embodiment;

FIG. 9 is an explanatory view of the operation of a symmetrical feature point extraction unit;

FIG. 10 is a flowchart of the shake calculation method according to an embodiment;

FIG. 11 and FIG. 12 are explanatory views of the method of extracting a symmetrical position feature point;

FIG. 13 illustrates an example of the size of an extraction area;

FIG. 14 is an explanatory view of the shake detection method according to another embodiment;

FIG. 15 is an explanatory view of a shake detection method according to another embodiment; and

FIG. 16 illustrates a configuration of the hardware relating to the image processing device according to an embodiment.

### DESCRIPTION OF EMBODIMENTS

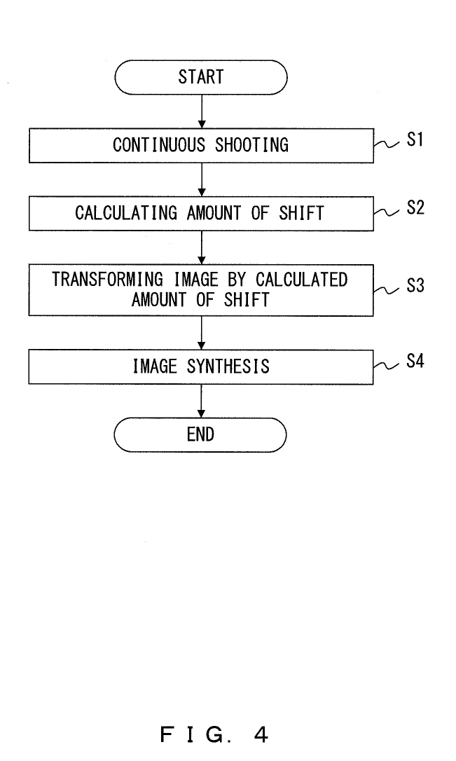

FIG. 4 is a flowchart of an example of the camera shake correcting process. In this example, two images obtained by continuous shooting are used to correct camera shake. The camera shake may be suppressed by making exposure time of shooting shorter than normal shooting. However, short exposure time increases noise in images. Thus, in order to suppress the noise, a plurality of images obtained by continuous shooting are synthesized. That is to say, by combining the short exposure time shooting and image synthesis processing, a camera-shake corrected image, in which noise is suppressed, can be obtained.

In step S1, two images (first and second images) are generated by continuous shooting with shorter exposure time than usual. In step S2, the amount of shift of the second image with respect to the first image is calculated. In step S3, the second image is transformed to correct the calculated amount of shift. In step S4, the first image is synthesized with the transformed second image. Thus, the camera-shake corrected image is generated.

In step S3, for example, an affine transformation is performed by the equation (1) below.

$$( \begin{matrix}{x}^{′} \\ {y}^{′} \\ 1\end{matrix} ) = ( \begin{matrix}S cos θ & - S sin θ & dx \\ S sin θ & S cos θ & dy \\ 0 & 0 & 1\end{matrix} ) ( \begin{matrix}x \\ y \\ 1\end{matrix} ) \qquad ( 1 )$$

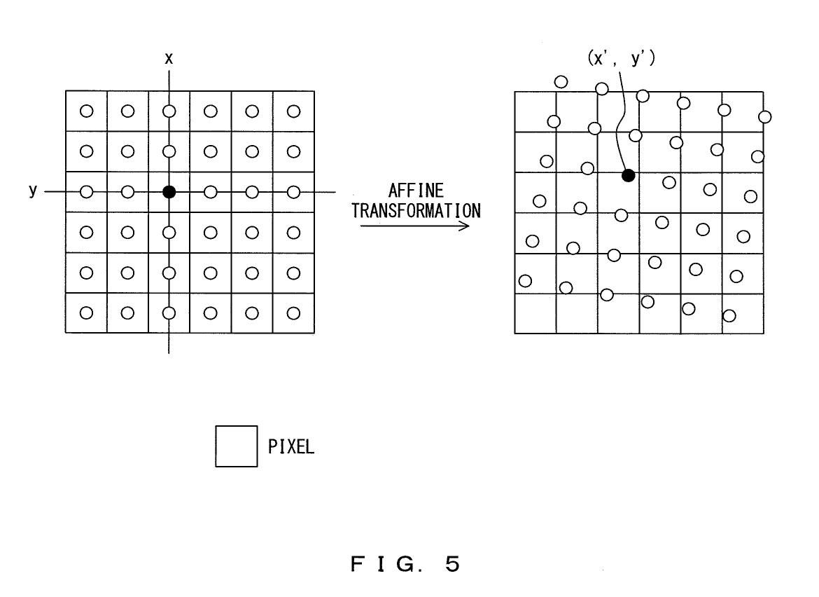

“dx” indicates the amount of horizontal shift, and “dy” indicates the amount of vertical shift. “θ” indicates the rotation angle of the shift of the camera in the ROLL direction. “S” indicates the enlargement/reduction rate generated by the movement of the camera in the perspective direction. (x, y) indicates the coordinates of the image before the transformation. (x′, y′) indicates the coordinates of the transformed image. FIG. 5 illustrates an example of an image transformation by the affine transformation. In the example illustrated in FIG. 5, the image is translated and rotated clockwise by the affine transformation.

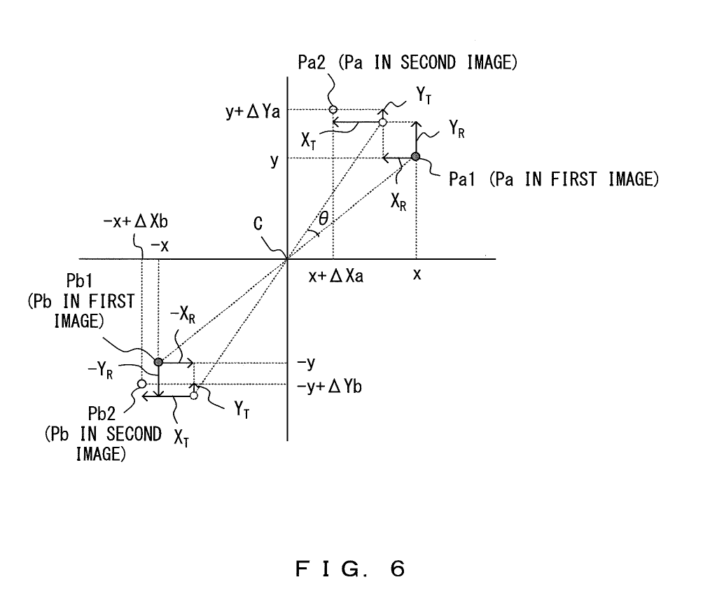

FIG. 6 is an explanatory view of the shake detection method according to an embodiment. In this example, it is assumed that the amount of shift between the two images (first and second images) obtained by continuous shooting is detected. It is also assumed in this example that the translation component and the rotation component coexist, but no enlargement/reduction component is included.

It is preferable that the time interval in shooting the two images is short enough not to make a large movement of the camera for shooting the images during the time interval. That is, it is preferable that the time interval in shooting the two images is short in such a way that same subject area is included in the two images.

In the explanation below, the amount of shift is detected using a pair of feature points Pa and Pb. The feature points Pa and Pb are respectively referred to as feature points Pa1 and Pb1 in the first image, and as feature points Pa2 and Pb2 in the second image.

In the detection method in the present embodiment, in the first image (reference image), a pair of feature points Pa and Pb (Pa1, Pb1 in FIG. 6) located in the symmetrical positions about the central point C are extracted. In this example, the coordinates of the central point C of the image are defined as (0, 0). Therefore, the coordinates of the feature point Pa1 are (x, y), and the coordinates of the feature point Pb1 are (−x, −y).

In the second image (searched image), the feature points Pa and Pb (Pa2, Pb2 in FIG. 6) are searched. In this case, the second image has moved by camera shake with respect to the first image. It is assumed that the amount of movement of the feature point Pa (that is the motion vector of the feature point Pa) is “ΔXa, ΔYa” , and the amount of movement of the feature point Pb (that is, the motion vector of feature point Pb) is “ΔXb, ΔYb”. In other word, the coordinates of the feature point Pat are (x+ΔXa, y+ΔYa), and the coordinates of the feature point Pb2 are (−x+ΔXb, −y+ΔYb). When the camera shake includes the rotation component, the amount of movement of the feature point Pa is different from the amount of movement of the feature point Pb in most cases.

The amount of horizontal movement ΔXa of the feature point Pa is a sum of the translation component X_{T} and the rotation component X_{R} as illustrated in FIG. 6. The amount of vertical movement ΔYa is a sum of the translation component Y_{T} and the rotation component Y_{R}. Accordingly, the following equations are obtained.

ΔXa=X_{T}+X_{R} (2)

ΔYa=Y_{T}+Y_{R} (3)

The amount of movement of the feature point Pb is expressed as a sum of the translation component and the rotation component as the feature point Pa. Note that, the translation component by camera shake is the same anywhere in the image. That is, the translation component of the image movement for the feature point Pb is the same as the feature point Pa, that is, X_{T}, Y_{T}. On the other hand, the rotation component of the image movement by camera shake depends on the position in the image. However, the feature points Pa and Pb are located in the symmetrical positions about the central point C. Therefore, when the rotation components of the amount of movement of the feature point Pa are X_{R}, Y_{R}, the rotation components of the amount of movement of the feature point Pb are −X_{R}, −Y_{R}. That is, the following equations are obtained

ΔXb=X_{T}−X_{R} (4)

ΔYb=Y_{T}−Y_{R} (5)

Furthermore, using the equations (2)-(5), the average values of the amount of movement of the feature points Pa and Pb are calculated. The average of movement in horizontal direction is as follows.

(ΔXa+ΔXb)/2={(X_{T}+X_{R})+(X_{T}−X_{R})}/2=X_{T}

The average of movement in vertical direction is as follows.

(ΔYa+ΔYb)/2={(Y_{T}+Y_{R})+(Y_{T}−Y_{R})}/2=Y_{T}

As described above, when the averaging operation of the amount of movement of each feature point is performed, the rotation components X_{R}, Y_{R} are cancelled. Therefore, the average of the amounts of movement of the feature points Pa and Pb indicate the translation components of the amounts of movement by camera shake. Accordingly, by calculating the average of the amounts of movement of the feature points Pa and Pb, the translation components X_{T}, Y_{T} of the camera shake is obtained.

The amounts of movement ΔXa, ΔYa of the feature point Pa is obtained by the difference between the coordinates of the feature point Pa in the first image and the coordinates of the feature point Pa in the second image (that is, the motion vector). Similarly, the amounts of movement ΔXb, ΔYb of the feature point Pb is obtained by the difference between the coordinates of the feature point Pb in the first image and the coordinates of the feature point Pb in the second image.

When the translation components X_{T}, Y_{T} of the camera shake are obtained as described above, the rotation components X_{R}, Y_{R} are calculated in the following equation by subtracting the translation component from the amount of movement of the feature point.

X_{R}=ΔXa−X_{T}

Y_{R}=ΔYa−Y_{T}

Therefore, the rotation angle θ of camera shake is obtained by the following equation.

θ=tan⁻¹(Y_{R}/X_{R})

Thus, in the detecting method according to the present embodiment, when the camera shake includes a translation and a rotation, the translation component and the rotation component is correctly separated.

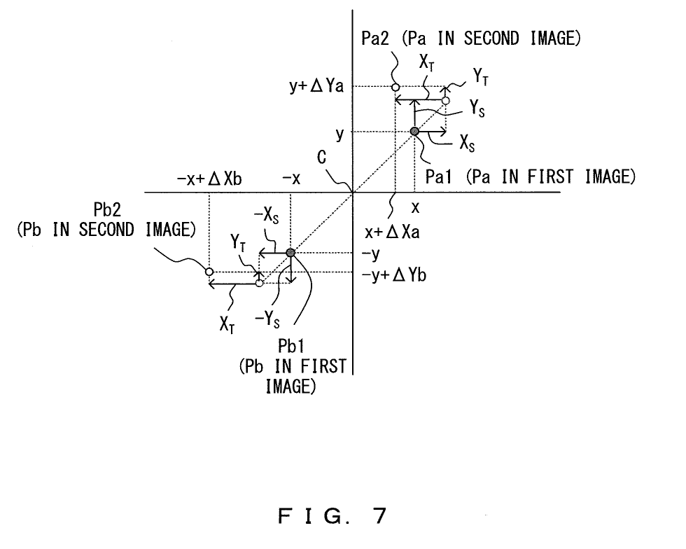

In the example illustrated in FIG. 7, the camera shake includes the translation component and the enlargement/reduction component. In this example, it is assumed that no rotation component is included. In this case, the amount of horizontal movement ΔXa of the feature point Pa is a sum of the translation component X_{T} and the enlargement/reduction component X_{S} as illustrated in FIG. 7. Similarly, the amount of vertical movement ΔYa of the feature point Pa is a sum of the translation component Y_{T} and the rotation component Y_{S}. Accordingly, the following equations are obtained.

ΔXa=X_{T}+X_{S} (6)

ΔYa=Y_{T}+Y_{S} (7)

The amount of movement of the feature point Pb is also expressed as a sum of the translation component and the enlargement/reduction component as the feature point Pa. Note that, the enlargement/reduction component of the image movement by the camera shake depends on the position in the image. However, the feature points Pa and Pb are located in the symmetrical positions about the central point C. Therefore, when the enlargement/reduction components of the amount of movement of the feature point Pa are X_{S}, Y_{S}, the enlargement/reduction components of the amount of movement of the feature point Pb are −X_{S}, −Y_{S}. Accordingly, the following equations are obtained.

ΔXb=X_{T}−X_{S} (8)

ΔYb=Y_{T}−Y_{S} (9)

Furthermore, the average value of the amounts of movement of the feature points Pa and Pb is calculated using the equations (6)-(9). The average of movement in horizontal direction is as follows.

(ΔXa+ΔXb)/2={(X_{T}+X_{S})+(X_{T}−X_{S})}/2=X_{T}

The average of movement in vertical direction is as follows.

(ΔYa+ΔYb)/2={(Y_{T}+Y_{S})+(Y_{T}−Y_{S})}/2=Y_{T}

Thus, although the camera shake includes a enlargement/reduction component, the average of the amounts of movement of the feature points Pa and Pb indicates the translation component of the amount of movement by camera shake as in the case in which the camera shake includes a rotation component. That is, also in this case, the translation components X_{T}, Y_{T} of camera shake is obtained by calculating the average of the amounts of movement of the feature points Pa and Pb.

When the translation components X_{T}, Y_{T} of camera shake are obtained as described above, the enlargement/reduction component X_{S}, Y_{S} can be calculated in the following equations by subtracting the translation component from the amount of movement of the feature point.

X_{S}=ΔXa−X_{T}

Y_{S}=ΔYa−Y_{T}

The enlargement/reduction rate S is calculated by (x+X_{S})/x or (y+Y_{S})/y, where “x” indicates the x coordinate of the feature point Pa (or Pb) in the first image, and “y” indicates the y coordinate of the feature point Pa (or Pb) in the first image.

As described above, when the camera shake includes a translation and enlargement/reduction in the detecting method according to the present embodiment, the translation component and the enlargement/reduction can be correctly separated.

In the detecting method according to the present embodiment, when the camera shake includes the translation component, a rotation component, and a enlargement/reduction component, each component can be separated using the feature points located in the positions symmetrical about the central point. That is, when an average of the amounts of movement of the feature points symmetrical located to each other is calculated, the rotation component and the enlargement/reduction component are cancelled and the translation component is calculated as described above with reference to FIG. 6 and FIG. 7. Then, if the translation component is subtracted from the amount of movement (difference in coordinates between the first and second images) of each feature point, “rotation component+enlargement/reduction component” is obtained.

The coordinates of one feature point in the first image is expressed as (x, y). In addition, in the second image, the coordinates obtained by subtracting the translation component from the coordinates of that feature point are set as (x′, y′). In this case, the affine transformation is expressed by the following equation, where “θ” indicates a rotation angle, and “S” indicates a enlargement/reduction rate.

$$( \begin{matrix}{x}^{′} \\ {y}^{′} \\ 1\end{matrix} ) = ( \begin{matrix}S cos θ & - S sin θ & 0 \\ S sin θ & S cos θ & 0 \\ 0 & 0 & 1\end{matrix} ) ( \begin{matrix}x \\ y \\ 1\end{matrix} ) \qquad ( 10 )$$

If the equation (10) is developed, the following equations are obtained.

x′=S(cos θ·x−sin θ·y)

y′=S(sin θ·x+cos θ·y)

Furthermore, by the equations (11)-(12), the rotation angle θ and the enlargement/reduction rate S are calculated.

$$\begin{matrix}S = \frac{{x}^{′}}{cos θ \cdot x - cos θ \cdot y} = \frac{{y}^{′}}{sin θ \cdot x + cos θ \cdot y} \\ tan θ = \frac{{xy}^{′} - {x}^{′} y}{{xx}^{′} - {yy}^{′}} & ( 11 ) \\ θ = {tan}^{- 1} ( \frac{{xy}^{′} - {x}^{′} y}{{xx}^{′} - {yy}^{′}} ) & ( 12 )\end{matrix}$$

Thus, by the shake detection method according to the present embodiment, the translation component, the rotation component, and the enlargement/reduction component of the camera shake can be separated with high accuracy by using the feature points located in the positions symmetrical about the central point of the image. Therefore, the image synthesis in the camera-shake correction can be appropriately performed if the image is corrected using the translation component, the rotation component, and the enlargement/reduction component calculated in the method above.

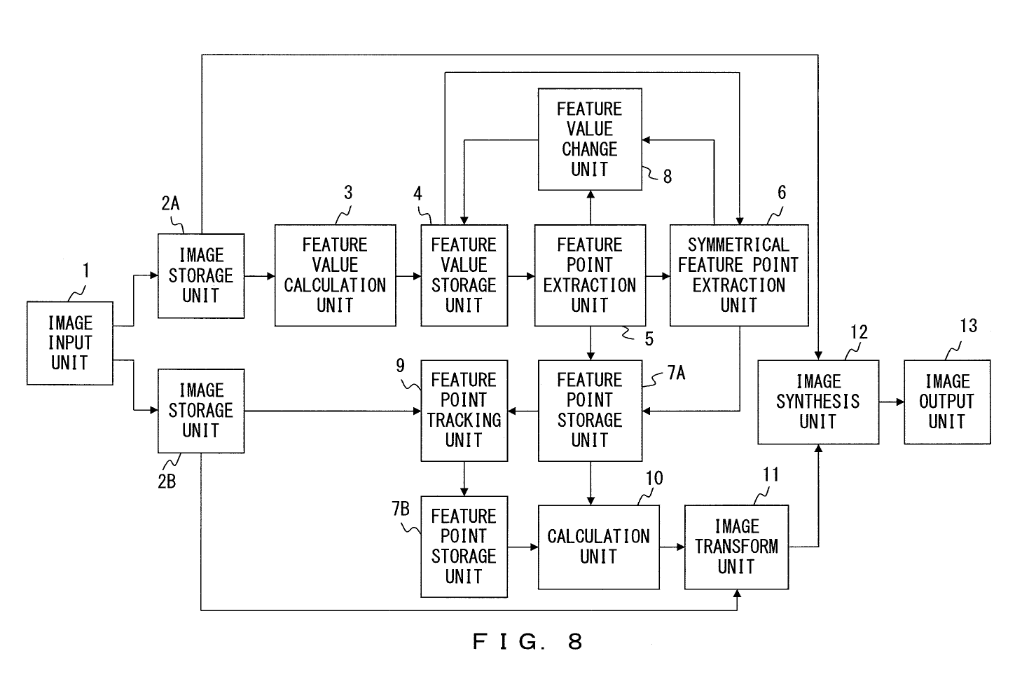

FIG. 8 illustrates a configuration of the image processing device having the shake detection function according to the embodiment. The image processing device is not specifically limited, but may be, for example, an electronic camera (or a digital camera).

An image input unit 1 is configured by, for example, a CCD image sensor or a CMOS image sensor, and generates a digital image. The image input unit 1 is provided with a continuously shooting function. In this embodiment, the image input unit 1 can obtain two continuous images (first and second images) shot in a short time by one operation on the shutter of a camera.

Image storage units 2A and 2B respectively stores the first and second images obtained by the image input unit 1. The image storage units 2A and 2B are, for example, semiconductor memory.

A feature value calculation unit 3 calculates the feature value of each pixel of the first image stored in the image storage unit 2A. The feature value of each pixel is calculated by, for example, a KLT method or a Moravec operator. Otherwise, the feature value of each pixel may be obtained by performing a horizontal Sobel filter operation and a vertical Sobel filter operation for each pixel, and multiplying the result of the filter operations. The feature value of each pixel may be calculated by other methods.

A feature value storage unit 4 stores feature value data indicating the feature value of each pixel calculated by the feature value calculation unit 3. The feature value data is stored by, for example, being associated with the coordinates of each pixel. Otherwise, the feature value data may be stored by being associated with a serial number assigned to each pixel.

A feature point extraction unit 5 extracts as a feature point a pixel whose feature value is larger than a threshold from the feature value data stored by the feature value storage unit 4. In this case, the threshold may be a fixed value, or may depend on a shooting condition etc. The feature point extraction unit 5 notifies a symmetrical feature point extraction unit 6 and a feature point storage unit 7A of the feature value and the coordinates (or a serial number) of the extracted feature point.

The symmetrical feature point extraction unit 6 refers to the feature value data stored in the feature value storage unit 4, and checks the feature value of the pixel at the position symmetrical about the central point with respect to one or more extracted feature points. Then, if a pixel whose feature value is large enough to be available as a feature point is found, the symmetrical feature point extraction unit 6 extracts the pixel as a symmetrical position feature point. The threshold for extraction of the symmetrical position feature point by the symmetrical feature point extraction unit 6 is not specifically restricted, but it can be smaller than the threshold for extraction of the feature point by the feature point extraction unit 5.

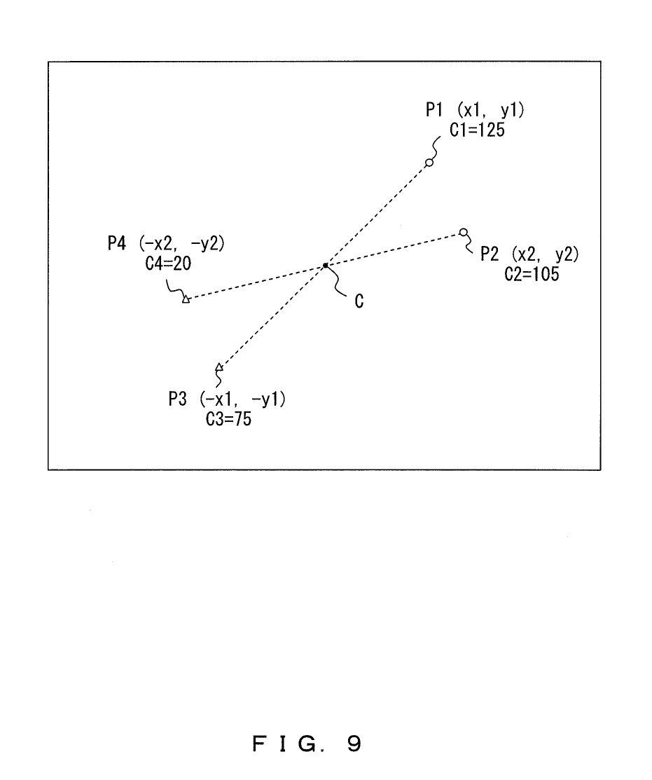

FIG. 9 is an explanatory view of the operation of the symmetrical feature point extraction unit 6. In this example, it is assumed that the feature point extraction unit 5 has extracted two pixels P1 and P2 as feature points. The coordinates of the pixel P1 are (x1, y1), and the coordinates of the pixel P2 are (x2, y2). In this example, the coordinates of the central point C of the image is defined as (0, 0). A feature value C1 of the pixel P1 is “125”, and a feature value C2 of the pixel P2 is “105”. In addition, the threshold for extraction of the symmetrical position feature point is 50 in this example.

In this case, first for the pixel (feature point) P1 indicating the largest feature value, the feature value of the pixel at the position symmetrical about the central point C is checked. That is, the feature value of the pixel positioned at the coordinates (−x1, −y1) is checked. In this example, a feature value C3 of a pixel P3 located at the coordinates (−x1, −y1) is “75”. The feature value C3 feature value C3 is larger than the threshold “50”. Thus, the pixel P3 can be used as a feature point. Therefore, the pixels P1 and P3 are selected as a pair of feature points located at symmetrical positions about the central point C.

Then, the feature value of the pixel at a symmetrical position about the central point C is checked for the pixel (feature point) P2 having the second largest feature value. That is, the feature value of the pixel located at the coordinates (−x2, −y2) is checked. In this example, a feature value C4 of a pixel P4 located at the coordinates (−x2, −y2) is “20”. In this case, since the feature value C4 is smaller than the threshold (=50), the pixel P4 cannot be used as a feature point. That is, the pixel P4 and the corresponding pixel P2 are not selected as a feature point.

In the example illustrated in FIG. 9, although only one pair of feature points located at the symmetrical positions about the central point are extracted, two or more pairs of symmetrical points may be extracted. That is, the above-mentioned procedure may be repeatedly performed until a desired number of pairs of feature points are obtained in the descending order from the pixel (feature point) having the largest feature value.

When a feature point is extracted, and if another feature point exists in the vicinal area, there is the possibility that an erroneous tracking occurs. Therefore, a feature value change unit 8 changes the feature value of the pixel located in a specified area including the feature point extracted by the feature point extraction unit 5 into zero in the feature value data stored in the feature value storage unit 4. The feature value of the pixel in the vicinal area of the symmetrical feature point extracted by the symmetrical feature point extraction unit 6 is also changed into zero. A pixel whose feature value is zero is not selected as a feature point or a symmetrical feature point. However, the image processing device according to the present embodiment may correct the camera shake without using the feature value change unit 8.

The feature point storage unit 7A stores the information about the feature point extracted by the feature point extraction unit 5 and the feature point (symmetrical feature point) extracted by the symmetrical feature point extraction unit 6. In the example illustrated in FIG. 9, the following information is written to the feature point storage unit 7A.
Feature point P1: coordinates (x1, y1), feature value C1=125, symmetrical feature point=P3
Feature point P3: coordinates (−x1, −y1), feature value C3=75, symmetrical feature point=P1

A feature point tracking unit 9 tracks each feature point stored by the feature point storage unit 7A in the second image stored in the image storage unit 2B. In the example in FIG. 9, feature points P1 and P3 are tracked in the second image. Tracking a feature point is not specifically restricted, but may be performed by, for example, a method adopted in the KLT method or the Moravec operator. The information about each feature point tracked by the feature point tracking unit 9 (coordinate information etc.) is written to a feature point storage unit 7B

A calculation unit 10 calculates the amount of shift between the first and second images using the feature points located in the symmetrical positions about the central point. For example, in the example illustrated in FIG. 9, the amount of shift is calculated using the feature points P1 and P3. The method of calculating the amount of shift using the feature points located in the symmetrical positions is described above with reference to FIG. 6 and FIG. 7. Therefore, the calculation unit 10 obtains the translation component, the rotation angle, and the enlargement/reduction rate of camera shake. When there are plural pairs of feature points located in the symmetrical positions, the amount of shift may be calculated using, for example, a method of averages such as the least squares etc.

An image transform unit 11 transforms the second image stored in the image storage unit 2B based on the amount of shift calculated by the calculation unit 10. In this case, the image transform unit 11 transforms each piece of pixel data of the second image so that, for example, the shift between the first and second images is compensated for. The transforming method is not specifically restricted, but may be, for example, an affine transformation.

An image synthesis unit 12 synthesizes the first image stored in the image storage unit 2A with the transformed second image obtained by the image transform unit 11. Then, an image output unit 13 outputs the synthesized image obtained by the image synthesis unit 12. Thus, a camera-shake corrected image is obtained.

The image processing device with the above-mentioned configuration can be realized as a hardware circuit. The function of a part of the image processing device can also be realized by software. For example, all or a part of the feature value calculation unit 3, the feature point extraction unit 5, the symmetrical feature point extraction unit 6, the feature value change unit 8, the feature point tracking unit 9, the calculation unit 10, the image transform unit 11, and the image synthesis unit 12 may be realized by software.

In the embodiment above, the amount of shift is calculated using only the feature points located in the symmetrical positions about the central point, but other feature point may also be used together. For example, a first amount of shift is calculated using one or more pairs of feature points located in the symmetrical positions, and a second amount of shift is calculated based on the amount of movement of another feature point. In the example illustrated in FIG. 9, a pair of symmetrical feature points P1 and P3, and another feature point P2 are used. Then, an average is calculated for a plurality of calculation results by the least squares. In addition, a specified number of feature points may be used. In this case, if the number of feature points located in the symmetrical positions is smaller than the specified number, another feature point is used together. Then, the amount of shift is calculated using all extracted feature points.

In the embodiment above, the image transform unit 11 transforms the second image using the first image as a reference image, but the embodiment is not limited to the method. That is, the first shot image can be a reference image, and the second shot image can be a reference image. In addition, for example, the first and second images may be transformed by the half of the calculated amount of shift.

Furthermore, when the feature point is extracted, the feature point included in the movement area of the subject in the image may be excluded. That is, when the subject movement area in the image is detected by the conventional technique, and the feature point extracted by the feature point extraction unit 5 is located within the subject movement area, the feature point may be prevented from being used in the camera shake correction processing.

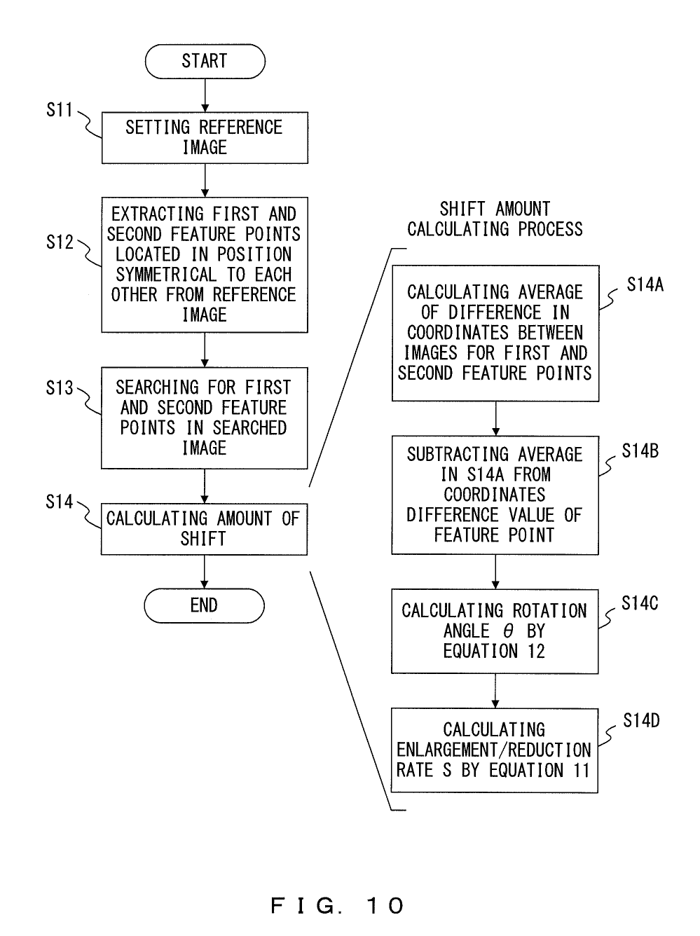

FIG. 10 is a flowchart of the shake calculation method according to the embodiment. The process in the flowchart is performed by the image processing device illustrated in FIG. 8 when continuous shooting is performed by an electronic camera

In step S11, the image input unit 1 prepares a reference image from among a plurality of images obtained by continuous shooting. Any one image in the plurality of images is selected as a reference image. In this case, the reference image may be a first shot image, or any other image. The image input unit 1 may continuously shoot three or more images. The image input unit 1 stores the reference image in the image storage unit 2A, and stores other image(s) as searched image(s) in the image storage unit 2B.

In step S12, a pair of feature points (first and second feature points) located in the symmetrical positions about the central point in the image are extracted from the reference image. That is, the feature value calculation unit 3 uses the KLT method etc. on each pixel of the reference image, and calculates the feature value. The feature point extraction unit 5 refers to the feature value data indicating the feature value of each pixel, and extracts a feature point (first feature point). Then, the symmetrical feature point extraction unit 6 extracts a feature point (second feature point) located in the symmetrical position with respect to the feature point extracted by the feature point extraction unit 5.

In step S13, the feature point tracking unit 9 searches for the first and second feature points extracted in step S12. The feature point is tracked in, for example, the KLT method. In step S14, the calculation unit 10 calculates the amount of shift using the coordinates of the pair of feature points obtained from the first image in step S12 and the coordinates of the pair of feature points obtained from the second image in step S13. Step S14 includes steps 14A through 14D described below.

In step S14A, an average of the difference between the coordinates of the images about the first feature point and the difference between the coordinates of the images about the second feature point is calculated. By the averaging process, as described above, the rotation component and the enlargement/reduction component of the camera shake are cancelled, and the translation component is calculated. In step S14B, in each feature point, the translation component obtained in step S14A is subtracted from the coordinates difference value between the images. The result of the subtraction is a sum of the rotation component and the enlargement/reduction component of the camera shake. In step S14C, the rotation angle θ is calculated by the equation (12) above. In step S14D, the enlargement/reduction rate S is calculated by the equation (11) above.

As described above, in the detecting method according to the embodiment, the amount of shift is detected using one or more pairs of feature points located in the symmetrical positions about the central point of the image. However, with respect to not only the feature points located in the symmetrical positions correctly about the central point, but also the feature points located in the approximately symmetrical about the central point, the rotation component and the enlargement/reduction component of the camera shake can be substantially cancelled by the averaging operation above. Therefore, in the detecting method according to the embodiment, the “symmetrical position” is not limited to the correctly symmetrical position, but includes a substantially or approximately symmetrical position.

As a result of calculating the amount of shift on plural pairs of feature points in step S14, a pair of feature points indicating the tendency different from those of other pairs may be excluded from the pairs to be processed. For example, when the feature points are located in the subject area in the image, and the subject itself has moved during the shooting of the two images, that is, the subject has been shifted in the images, the influence of the subject shift in addition to the camera shake is reflected by the feature points. The amount of shift calculated based on that pair of feature points indicates the tendency different from that of the amount of shift calculated based on the pair of feature points reflecting only the influence of the camera shake. Therefore, when the feature points including the influence of the subject shift are excluded from the pair to be processed, the degradation of calculation accuracy of the amount of shift by the camera shake is suppressed.

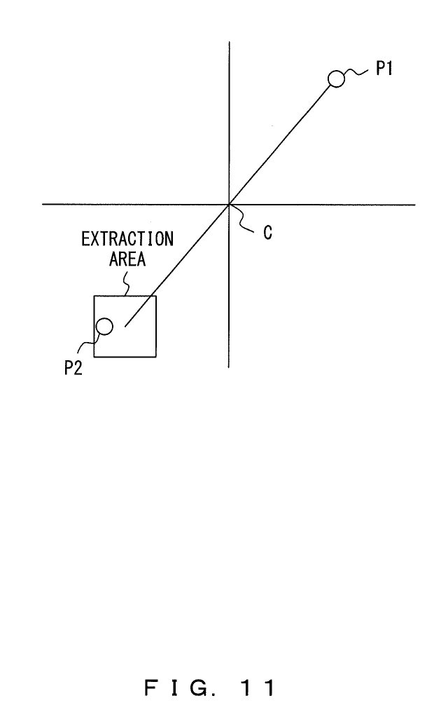

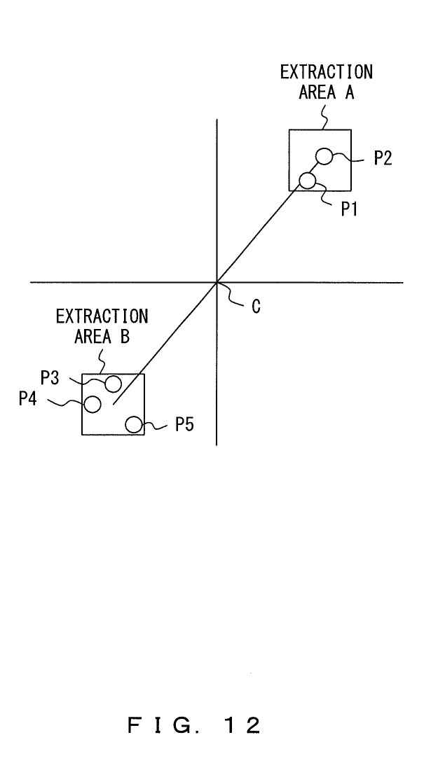

FIG. 11 and FIG. 12 are explanatory views of extracting a symmetrical position feature point. In the method illustrated in FIG. 11, the extraction area is provided in the position symmetrical with respect to the feature point P1 about the central point C of the image. In the extraction area, the pixel having feature value larger than the specified threshold is extracted as a symmetrical position feature point. In FIG. 11, the feature point P2 is extracted from the extraction area. In this case, when the feature value of a plurality of pixels is larger than the threshold in the extraction area, the pixel having the largest feature value is extracted as a symmetrical position feature point. According to this method, a pair of feature points located in the positions symmetrical to each other can be easily extracted. In this method, an error depending on the size of the extraction area is generated. However, by appropriately determining the size of the extraction area, and/or by increasing the number of feature points to be extracted, the error can be absorbed successfully.

In the method illustrated in FIG. 12, a pair of extraction areas are provided in the position symmetrical about the central point C of the image. In this example, the extraction areas A and B are provided. The size of the pair of extraction areas is not specifically limited, but it is preferable that they are in the same size. In each extraction area, a pixel having a feature value larger than the threshold is detected as a feature point. In this example, the feature points P1 and P2 are detected in the extraction area A, and the feature points P3, P4, and P5 are detected in the extraction area B. Then, the same number of feature points is extracted from each extraction area.

For example, the feature points P1 and P2 are extracted from the extraction area A, and the feature points P3 and P4 are extracted from the extraction area B. That is, two pairs of feature points “P1 and P3” and “P2 and P4” located in the symmetrical positions are extracted. Otherwise, it is also possible that the feature point P1 is repeatedly used. That is, three pairs of feature points “P1 and P3”, “P2 and P4”, and “P2 and PS” located in the symmetrical positions may be extracted.

In the method illustrated in FIG. 12, it is assumed that the feature value of the feature points detected in each extraction area is not close to each other. For example, the feature values of the feature points P1 and P2 are not close to each other. In the method illustrated in FIG. 12, the feature value change unit 8 may stop changing the feature value of pixels for the pixel in the extraction area.

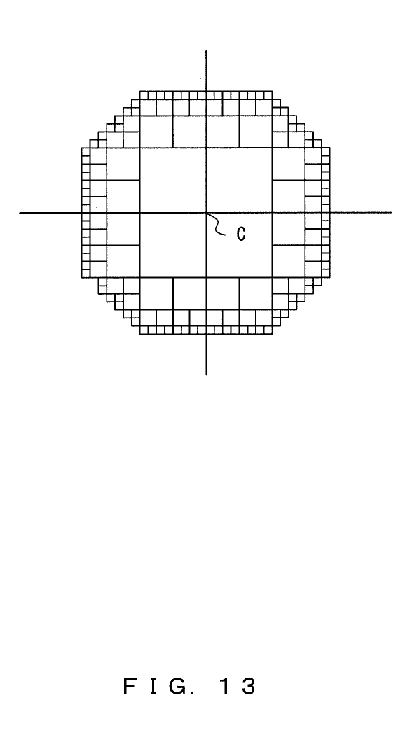

FIG. 13 illustrates an example of the size of an extraction area illustrated in FIG. 11 or FIG. 12. In this embodiment, the size of the extraction area is set the smaller as the distance from the central point of the image becomes the longer. In this case, in the area close to the central point of the image, the rotation component and the enlargement/reduction component of the camera shake are small. Therefore, in the area close to the central point of the image, an error of the amount of shift is small even if the extraction area is larger. On the other hand, in the area far from the central point of the image, the rotation component and the enlargement/reduction component of the camera shake becomes large. Therefore, in the area far from the central point of the image, an error of the amount of shift is suppressed by reducing the extraction area. The size of the extraction area may be set to be inversely proportional to the distance from the central point C of the image.

### Other Embodiments

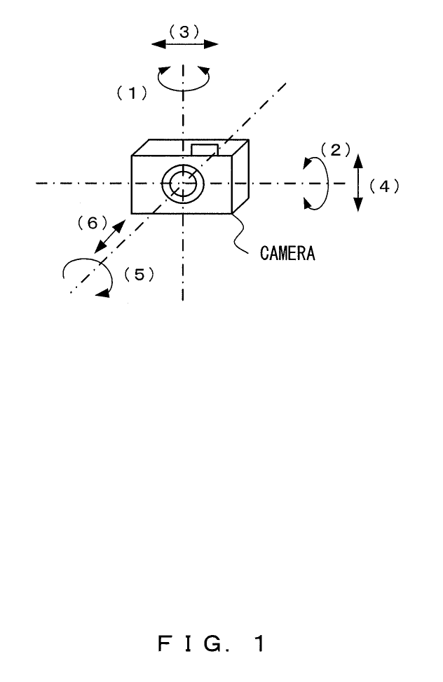

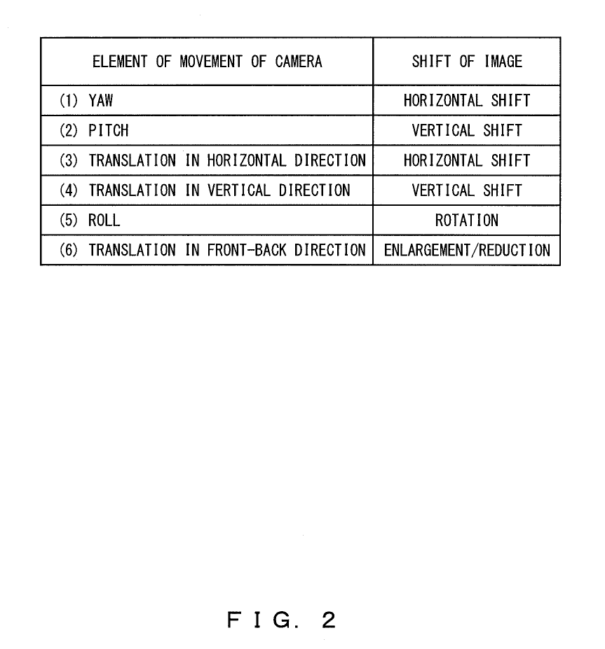

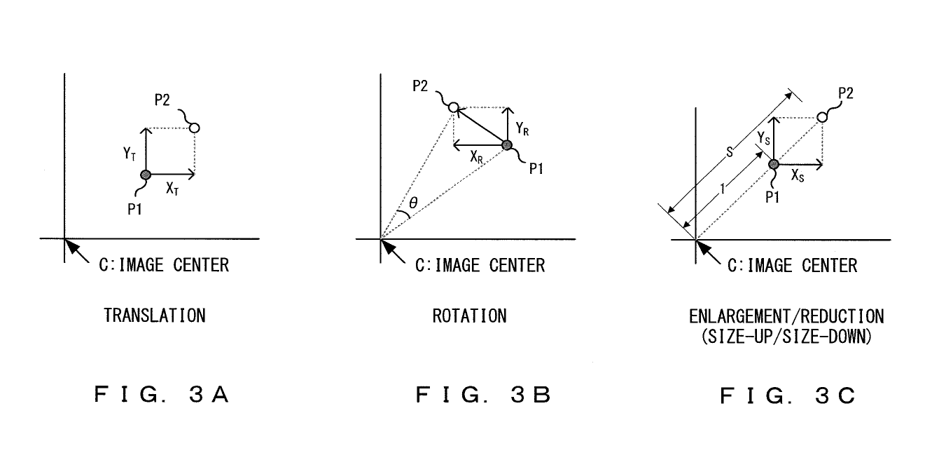

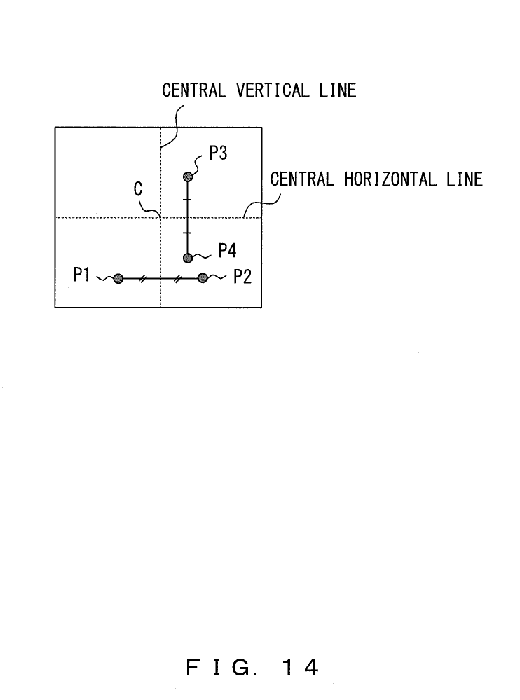

FIG. 14 is an explanatory view of the shake detection method according to another embodiment. The detecting method is used when the camera shake includes substantially no rotation shift (ROLL illustrated in FIG. 1 and FIG. 2). The image according to this assumption is obtained by a camera (monitor camera etc.) fixed not to generate camera shake in the rotation direction.

In FIG. 14, the feature points P1 and P2 located in the positions symmetrical about the vertical line (central vertical line) passing the central point C of the image are extracted. When the amount of movement of the pair of feature points P1 and P2 between the images is averaged, the amount of horizontal shift caused by the enlargement/reduction is cancelled. Similarly, the feature points P3 and P4 located in the positions symmetrical about the horizontal line (central horizontal line) passing the central point C of the image are extracted. When the amount of movement of the pair of feature points P3 and P4 between the images is averaged, the amount of vertical shift caused by the enlargement/reduction is cancelled. That is, if a pair of feature points located in the positions symmetrical about the central vertical line and a pair of feature points located in the positions symmetrical about the central horizontal line are extracted, the enlargement/reduction component of the camera shake can be cancelled. By so doing, the translation component of the camera shake is obtained. Furthermore, if “θ=0” is substituted in the equation (11), the enlargement/reduction rate S is obtained.

Thus, if it is known in advance that the camera shake includes substantially no rotation component, the translation component of the camera shake can be separated from the enlargement/reduction component using the feature points located in the position symmetrical about the central line (central vertical line and central horizontal line).

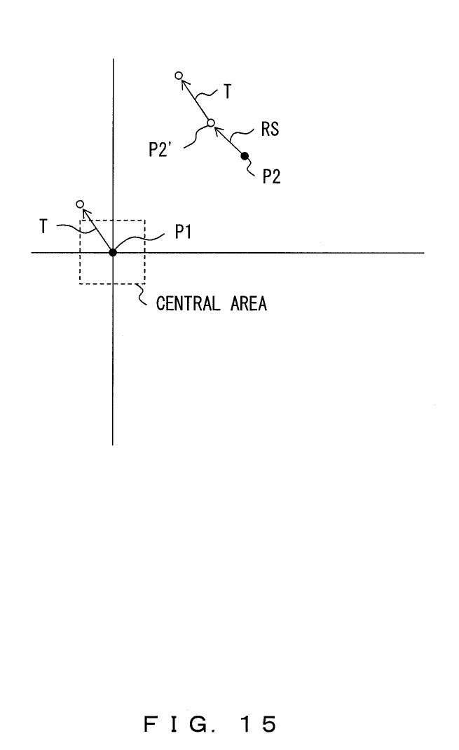

FIG. 15 is an explanatory view of a shake detection method according to still another embodiment. In the detection method, the amount of shift is calculated using the feature point located in the central area of the image. In the example illustrated in FIG. 15, the feature point P1 located in the central area and the feature point P2 located outside the central area are used.

In this case, the movement of the feature point P2 between the first image and the second image includes the translation component, the rotation component, and the enlargement/reduction component. In FIG. 15, the arrow T indicates the translation component, and the arrow RS indicates the sum of the rotation component and the enlargement/reduction component. On the other hand, since the feature point P1 is located in the central area of the image, the rotation component and the enlargement/reduction component are substantially zero between the first and second images. That is, the movement of the first feature point P1 is substantially the translation component only. Therefore, the translation component T of the camera shake is obtained by calculating the difference between the coordinates of the feature point P1 in the first image and the coordinates of the feature point P1 in the second image (that is, the motion vector of the feature point P1).

In addition, the translation component T is subtracted from the amount of movement of the feature point P2. Thus, the sum of the rotation component and the enlargement/reduction component of the camera shake are obtained. Furthermore, by the equations (11) and (12), the rotation angle θ and the enlargement/reduction rate S of the camera shake are calculated. In the equations (11) and (12), (x, y) indicates the coordinates of the feature point P2 in the first image, and (x′, y′) indicates the coordinates of the point P2′ illustrated in FIG. 15.

Thus, in the shake detection method illustrated in FIG. 15, the translation component, the rotation component, and the enlargement/reduction component of the camera shake can be appropriately separated although there are no feature points in the symmetrical positions about the central point of the image.

Hardware Configuration

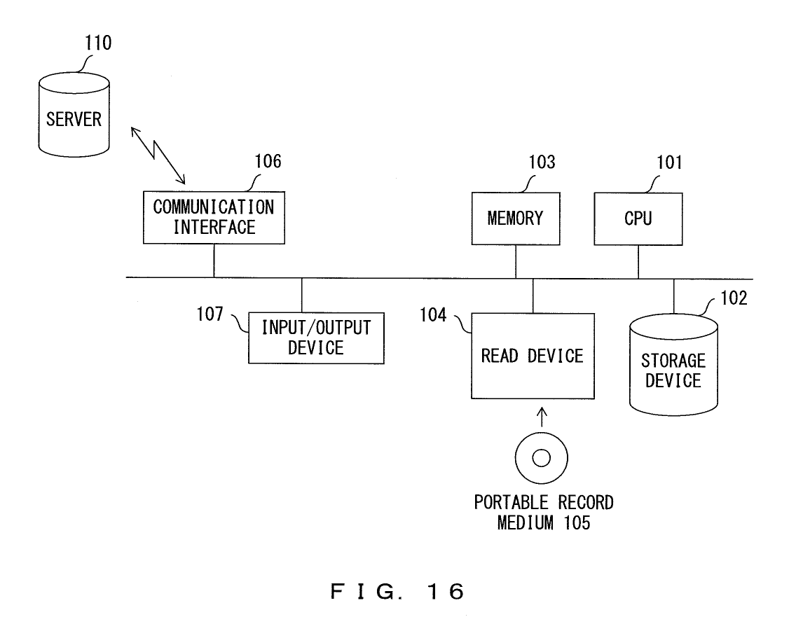

FIG. 16 illustrates a configuration of the hardware relating to the image processing device according to the embodiments. In FIG. 16, a CPU 101 executes an image processing program according to the embodiment using memory 103. The image processing program according to the embodiment describes the operation and/or procedure according to the embodiment. A storage device 102 is, for example, a hard disk, and stores an image processing program. The storage device 102 may be an external record device. The memory 103 is, for example, semiconductor memory, and configured to include a RAM area and a ROM area. The image storage units 2A and 2B, the feature value storage unit 4, and the feature point storage units 7A and 7B illustrated in FIG. 8 may be realized using the memory 103.

A read device 104 accesses a portable record medium 105 at an instruction of the CPU 101. It is assumed that the portable record medium 105 may be realized by, for example, a semiconductor device, a medium to and from which information is input and output by the magnetic effect, or a medium to and from which information is input and output by an optical effect. A communication interface 106 transmits and receives data through a network at an instruction of the CPU 101. An input/output device 107 corresponds to a display device etc. or a device for receiving an instruction from a user in this embodiment.

The image processing program according to the present embodiment is provided by, for example:
(1) being installed in advance in the storage device 102;
(2) being provided by the portable record medium 105; and
(3) being downloaded from a program server 110.

Then, the computer with the above-mentioned configuration executes the image processing program, thereby realizing the image processing device according to the embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment (s) of the present inventions has (have) been described in detail, it should be understood that the various changes, substitutions, and alterations could be made hereto without departing from the spirit and scope of the invention.

What is claimed is:

1. A method of calculating camera shake using first and second images obtained by continuous shooting, comprising:
extracting first and second feature points located in positions symmetrical about a central point in the first image;
searching for the first and second feature points in the second image; and
calculating the camera shake based on coordinates of the first and second feature points extracted from the first image and coordinates of the first and second feature points searched for in the second image.

2. The method according to claim 1, further comprising
calculating a translation component of the camera shake by averaging a difference in coordinates of the first feature point between the first and second images, and a difference in coordinates of the second feature point between the first and second images.

3. The method according to claim 2, further comprising
calculating a rotation component and a enlargement/reduction component of the camera shake by subtracting the translation component from a difference in coordinates of the first feature point between the first and second images.

4. The method according to claim 1, further comprising:
extracting another pair of feature points located in positions symmetrical about the central point until a total number of extracted feature points reaches a specified threshold when a number of feature points located in positions symmetrical about the central point is smaller than the threshold; and
calculating the camera shake using the feature points located in positions symmetrical about the central point and the other feature point.

5. The method according to claim 1, further comprising:
providing an extraction area in a position symmetrical with respect to the first feature point about the central point in the first image; and
extracting the second feature point from the extraction area.

6. The method according to claim 5, wherein
a size of the extraction area is smaller as the extraction area is located farther from the central point.

7. The method according to claim 1, further comprising:
providing a pair of extraction areas in positions symmetrical about the central point in the first image; and
extracting one or more first feature points from one of the extraction areas, and extracting one or more second feature points from the another extraction area.

8. The method according to claim 7, wherein
a size of the extraction area is smaller as the extraction area is located farther from the central point.

9. A method of calculating camera shake using first and second images obtained by continuous shooting, comprising:
extracting first and second feature points located in positions symmetrical about a horizontal line or a vertical line passing a central point in the first image;
searching for the first and second feature points in the second image; and
calculating a translation component and a enlargement/reduction component of the camera shake based on coordinates of the first and second feature points extracted from the first image and coordinates of the first and second feature points searched for in the second image.

10. A method of calculating camera shake using first and second images obtained by continuous shooting, comprising:
extracting a first feature point from a central area of the first image;
extracting a second feature point from an area other than the central area of the first image;
searching for the first and second feature points in the second image;
calculating a translation component of the camera shake based on a difference in coordinates of the first feature point between the first and second images; and
calculating a rotation component and a enlargement/reduction component of the camera shake based on a difference in coordinates of the second feature point between the first and second images and the translation component.

11. An image processing device which corrects camera shake using first and second images obtained by continuous shooting, comprising:
an extraction unit to extract first and second feature points located in positions symmetrical about a central point in the first image;
a search unit to search for the first and second feature points in the second image;
a calculation unit to calculate the camera shake based on coordinates of the first and second feature points extracted from the first image and coordinates of the first and second feature points searched for in the second image;
a transform unit to transform the second image using the calculated camera shake obtained by the calculation unit; and
a synthesis unit to synthesize the first image and the transformed second image obtained by the transform unit.

12. An image processing device which corrects camera shake using first and second images obtained by continuous shooting, comprising:
an extraction unit to extract first and second feature points located in positions symmetrical about a horizontal line or a vertical line passing a central point in the first image;
a search unit to search for the first and second feature points in the second image;
a calculation unit to calculate a translation component and a enlargement/reduction component of the camera shake based on coordinates of the first and second feature points extracted from the first image and coordinates of the first and second feature points searched for in the second image;
a transform unit to transform the second image using the calculated translation component and enlargement/reduction component of the camera shake obtained by the calculation unit; and
a synthesis unit to synthesize the first image and the transformed second image obtained by the transform unit.
